(19) United States
(12) Patent Application Publication
(10) Pub. No.: US 2009/0054613 A1
(43) Pub. Date: Feb. 26, 2009

(54) FAST DRYING POLYURETHANE COMPOSITION

(75) Inventors: AMIT SEHGAL, MARLTON, NJ (US); RICHARD ROSEN, PRINCETON, NJ (US); JEAN-MARIE BERNARD, SAINT-LAURENT D'AGNY (FR); PHILIPPE BARBEAU, GENAS (FR); PHILIPPE OLIER, LYON (FR); LICHANG ZHOU, LAWRENCEVILLE, NJ (US)

Correspondence Address: COZEN O'CONNOR, P.C., 1900 MARKET STREET, PHILADELPHIA, PA, 19103-3508, US

(73) Assignee: RHODIA, INC., CRANBURY, NJ (US)

(21) Appl. No.: 12/262,736

(22) Filed: Oct. 31, 2008

Related U.S. Application Data
(63) Continuation-in-part of application No. 12/095,239, filed on Oct. 3, 2008.
(60) Provisional application No. 61/001,374, filed on Oct. 31, 2007.

(30) Foreign Application Priority Data
Nov. 28, 2005 (FR) 0512036

(51) Int. Cl. C08G 18/32

(52) U.S. Cl. 528/60

(57) ABSTRACT

A fast drying polyurethane coating composition wherein the reactants comprise (a) a first component comprising one or more polyol compounds having a glass transition temperature of less than or equal to about 25° C., and preferably an Mw of 5000 or less, preferably acrylic or polyester polyols, and (b) a second component, comprising the reaction of a (poly)isocyanate oligomer having an average NCO functionality of greater than 2, for example a biuret with an NCO functionality of 3, with a compound X comprising a substrate portion comprising one or more cycloaliphatic rings, one or more heterocyclic rings, one or more aromatic rings, or a particle of a crosslinked polymer, and functional groups covalently bonded to such substrate portion, for example hydrogenated bisphenol A (HBPA).

### CROSS-REFERENCE TO RELATED APPLICATIONS

This is a Continuation in Part of Ser. No. 12/095,239 filed May 28, 2008, which is the national stage of PCT/EP2006/068987, filed Nov. 28, 2006, which claimed priority from French application 0512036 filed Nov. 28, 2005. Benefit of provisional application Ser. No. 61/001,374 filed Oct. 31, 2007, is claimed. Each of these prior applications is hereby incorporated by reference.

### FIELD OF THE INVENTION

The present invention is directed to a polyurethane coating composition, more specifically to a two component polyurethane coating composition that is fast drying under ambient non-elevated temperature conditions.

### BACKGROUND OF THE INVENTION

Two component polyurethane coatings are typically made by mixing a “Part A”, which typically contains one or more polyols, a solvent, and other additives, with a “Part B” which typically contains one or more polyisocyanates, a solvent, and other additives, prior to application of the coating onto a substrate. There is an increasing interest in improving the fast-dry or fast-cure properties of such two component polyurethane coatings in order to reduce process time and improve productivity. This is especially valuable in automotive refinish applications where reduced drying time translates directly to faster handling, reduced process time in dust free environments, and enabling subsequent process steps to be performed sooner.

### SUMMARY OF THE INVENTION

In a first aspect, the present invention is directed to a two component polyurethane coating composition, comprising a mixture comprising:
(a) a first component comprising one or more polyol compounds having a glass transition temperature of less than or equal to about 25° C., and
(b) a second component, comprising the reaction of a (poly)isocyanate oligomer having an average NCO functionality of greater than 2 with a compound X comprising a substrate portion comprising one or more cycloaliphatic rings, one or more heterocyclic rings, one or more aromatic rings, or a particle of a crosslinked polymer, and functional groups covalently bonded to such substrate portion, wherein the functional groups comprise:
   (i) one or more functional groups according to:

—B(H)ₙ
wherein:
   n is a number equal to 1 or 2,
   H is a labile hydrogen and
   B is O, S, N, N is a primary or secondary nitrogen, or groups —C(═O)O, C—(═O)N, O═P(O)₂; O═P(O)OR₁; O═P(O)₃; O═P(O)₂OR₁; or O═P(O)—OR₁, and
   R₁ is an alkyl or aralkyl radical, optionally branched, or an alkyl chain interrupted by a heteroatom; or
(ii) one or more functional groups according to:

B′(H)_{n′}
wherein:
   n′ is a number equal to 1, 2 or 3,
   H is a labile hydrogen,
   B is —SiR₂R₃R₄, and
   R₂, R₃, and R₄ are each independently oxygen, an alkyl radical substituted with a reactive (poly)isocyanate group, or a radicals such as aralkyl, aryl, —O-alkyl, or —O-aralkyl,
further provided that:
(iii) when B is a secondary nitrogen atom, and the substrate portion of compound X comprises a cycloaliphatic ring, then the substrate portion of compound X must comprise at least two such cycloaliphatic rings, and
(iv) the reaction is conducted with a weight fraction of compound X/[compound X+(poly) isocyanate] of not more than 50%.

In some embodiments the one or more polyol compounds having a glass transition temperature of less than or equal to about 25° C. and a molecular weight, Mw, of less than 5000. The most preferred polyols are acrylic or polyester and have a M_{w} and Tg such that Mw (g/mol)+500 times Tg (° C.) is less than 17500.

In some embodiments the second component is the triisocyanate reaction product of a biuret prepared from hexamethylene diisocyanate (HDI) with a molar deficiency of hydrogenated bis-phenol A (HBPA). In terms of weight ratio, a preferred weight ratio range of HBPA to biuret is about 5/100 to 25/100.

### BRIEF DESCRIPTION OF THE DRAWINGS

FIG. 1 shows a typical track left behind by the BK Drytime recorder used in the Examples, showing T₀-T₄ indicators to mark various drying stages.

### DETAILED DESCRIPTION

In one embodiment, the polyol component of the present invention comprises one or more polyol compounds having a glass transition temperature (“T_{g}”) of less or equal to about 25° C., more typically less than or equal to 20° C., even more typically less than or equal to 0° C. T_{g} is determined by known methods, such as differential scanning calorimetry.

In one embodiment, the polyol component of the present invention comprises one or more polyol compounds having a weight average molecular weight of less than or equal to 15,000 grams per mole, more typically less than or equal to 5,000 grams per mole, and even more typically, from about 1000 to about 3,000 grams per mole. Molecular weights may be determined by gel permeation chromatography using polystyrene standards.

In one embodiment, the polyol component of the present invention comprises one or more polyol compounds having a glass transition T_{g} of less than or equal to about 25° C., more typically less than or equal to 20° C., even more typically less than or equal to 0° C. and a weight average molecular weight of less than or equal to 15,000 grams per mole, more typically less than or equal to 5,000 grams per mole, and even more typically, from about 1000 to about 3,000 grams per mole.

In one embodiment, the polyol has:
(i) a T_{g} of less than or equal to 25° C. and a weight average molecular weight of less than or equal to 5,000 grams per mole, or
(ii) a T_{g} of less than or equal to 10° C. and a weight average molecular weight of less than or equal to 10,000 grams per mole, or
(iii) a T_{g} of less than or equal to 0° C. and a weight average molecular weight of less than or equal to 15,000 grams per mole.

In one embodiment, the polyol has a T_{g} of less than or equal to 25° C. and a weight average molecular weight of less than or equal to 5,000 grams per mole.

In one embodiment, the polyol has a T_{g} of less than or equal to 10° C. and a weight average molecular weight of less than or equal to 10,000 grams per mole.

In one embodiment, the polyol has a T_{g} of less than or equal to 0° C. and a weight average molecular weight of less than or equal to 15,000 grams per mole.

In one embodiment, the polyol has a hydroxyl number of from about 50 to about 200, more preferably from about 100 to about 175. As used herein, the terminology “hydroxyl number” means the amount of hydroxyl groups per unit weight of sample and is expressed in milligrams KOH per gram of sample (mg KOH/g).

Suitable polyol compounds are known in the art and include, for example, polyether polyols, polyester polyols, polyacrylate polyols, and mixtures or copolymers thereof.

Suitable polyether polyols include, for example, ethoxylation or propoxylation products of water or diols, such as, for example, polyether polyols that are commercially available under the tradename Desmophen™ polyether polyols from Bayer AG, under the trade name Chempol™ polyester polyols from Cook Composites and Polymers (CCP) Co.

Suitable polyester polyols are, for example, made by known polycondensation reaction of one or more acid or corresponding anhydride with one or more polyhydric alcohol. Suitable acids for example, benzoic acid, maleic acid, adipic acid, phthalic acid, isophthalic acid, terephthalic acid and sebacic acid as well as their corresponding anhydrides, and dimerism fatty acids and trimetric fatty acids and short oils. Suitable polyhydric alcohols include, for example, ethylene glycol, 1,4-butanediol, 1,6-hexane diol, neopentyl glycol, tetraethylene glycol, polycarbonate diols, trimethylolpropane and glycerol.

In a highly preferred embodiment, the polyol comprises a polyacrylate polyol. Suitable acrylic polyols are made, for example, by known copolymerization reactions of one or more hydroxyalkyl(meth)acrylate monomers, such as, for example, hydroxy(C₁-C₈)alkyl (meth)acrylates, with one or more acrylate monomers, such as, for example, (C₁-C₁₀)alkyl acrylates and cyclo(C₆-C₁₂)alkyl acrylates, or with one or more methacrylate monomers, such as, for example, (C₁-C₁₀)alkyl methacrylates, and cyclo(C₆-C₁₂)alkyl methacrylates, or with one or more vinyl monomer, such as, for example, styrene, α-methylstyrene, vinyl acetate, vinyl versatate, or with a mixture of two or more of such monomers. Suitable hydroxyalkyl(meth)acrylate monomers include for example, hydroxyethyl acrylate, hydroxypropyl acrylate, hydroxyethyl methacrylate, hydroxypropyl methacrylate. Suitable alkyl (meth)acrylate monomers include, for example, methyl methacrylate, ethyl methacrylate, butyl methacrylate, butyl acrylate, ethylhexyl methacrylate, isobornyl methacrylate. Suitable polyacrylate polyols include, for example, hydroxy(C₂-C₈)alkyl (meth)acrylate-co-(C₂-C₈)alkyl (meth)acrylate copolymers.

The polyisocyanate component of the composition of the present invention comprises one or more polyisocyanate oligomers having a T_{g} of greater than or equal to about −60° C., more typically greater than or equal to −20° C., even more typically from about −10° C. to about 15° C.

In one embodiment, the polyisocyanate component of the present invention comprises one or more polyisocyanate compounds having a having an average isocyanate functionality of at least 2.5 per molecule, more especially at least 3.5 per molecule.

In one embodiment, the polyisocyanate component of the composition of the present invention comprises one or more polyisocyanate oligomers having a T_{g} of greater than or equal to about −60° C., more typically greater than or equal to −20° C., even more typically from about −10° C. to about 15° C. and an average isocyanate functionality of at least 2.5 per molecule, more especially at least 3.5 per molecule.

In one embodiment, the isocyanate component of the composition of the present invention comprises products of the reaction of a (poly)isocyanate oligomer having an average NCO functionality of greater than 2 with a compound X comprising a substrate portion comprising one or more cycloaliphatic rings, one or more heterocyclic rings, one or more aromatic rings, or a particle of a crosslinked polymer, and functional groups covalently bonded to such substrate portion, wherein the functional groups comprise:

(i) one or more functional groups according to:

—B(H)ₙ
wherein:
   n is a number equal to 1 or 2,
   H is a labile hydrogen and
   B is O, S, N, N is a primary or secondary nitrogen, or groups —C(═O)O, C—(═O)N, O═P(O)₂; O═P(O)OR₁; O═P(O)₃; O═P(O)₂OR₁; or O═P(O)—OR₁, and
   R₁ is an alkyl or aralkyl radical, optionally branched, or an alkyl chain interrupted by a heteroatom; or
(ii) one or more functional groups according to:

B′(H)_{n′}
wherein:
   n′ is a number equal to 1, 2 or 3,
   H is a labile hydrogen,
   B is —SiR₂R₃R₄, and
   R₂, R₃, and R₄ are each independently oxygen, an alkyl radical substituted with a reactive (poly)isocyanate group, or a radicals such as aralkyl, aryl, —O-alkyl, or —O-aralkyl,
further provided that:
(iii) when B is a secondary nitrogen atom, and the substrate portion of compound X comprises a cycloaliphatic ring, then the substrate portion of compound X must comprise at least two such cycloaliphatic rings, and
(iv) the reaction is conducted with a weight fraction of compound X/[compound X+(poly) isocyanate] of not more than 50%.

The compound of the invention has isocyanate functionality, which means it has in its structure isocyanate functions, and it may also have the functions of other types such as urethane, allophanate, urea, biuret, ester, carbonate.

In addition, this compound has an average isocyanate functionality of more than 2, especially of at least 2.5, and more particularly at least 2.8. According to one preferred embodiment, this isocyanate functionality can be average at least 3, more specifically at least 3.2 and, in an even more preferential, of at least 3.5. This average isocyanate functionality is generally up to 20, more particularly 15 and even more particularly up to 10.

For this compound intended here and in the rest of the description, by average isocyanate functionality we refer to the number r:

r=Mₙ×[I]

wherein:
Mₙ is the number average molecular weight of feature isocyanate compound, and
[I] is the isocyanate based concentration expressed as mol/g.
   The mass Mn is determined by gel permeation chromatography.

The compound of the invention is the product of the reaction of at least one compound X with a (poly)isocyanate. We must understand that the invention also applies to cases where there is the reaction of (poly)isocyanate with a mixture of several compounds X.

As noted above, the compound X must have several characteristics.

It must first be understood to contain at least one function B(H)n or B′(H)′n, where H is a labile hydrogen and B represents different atoms or groups of atoms.

Thus, B can be designated O, the function being BH (OH in this case); S, in that event corresponding to the function SH; N, where the nitrogen is primary or secondary, which means that the nitrogen atom carries two or one hydrogen atom respectively, and which corresponds to the functions or NH₂ NH respectively. B can be further groups C(═O)—N, which corresponds to the function BH for C(═O)NH or C(═O)NH₂ or C(═O)—NHR, where ‘R’ is an alkyl chain, eventually branched, or aryl, generally from 1 to 10 carbon atoms. The values of B which have been mentioned here are patterns of preferential realization of the invention.

In addition, as noted above, B may represent a group consisting of phosphorus, in which case the —B(H)ₙ functional group is according to formula O═P(O)₂; O═P(O)OR₁; O═P(O)₃; O═P(O)₂OR₁; or O═P(O)—OR₁, where R₁ is as defined above, specifying here as an alkyl or aralkyl radical that includes more particularly up to 20 carbon atoms, in particular from 1 to 10 carbon atoms. In cases where R₁ denotes an alkyl chain interrupted by a heteroatom, the chain has a number of carbon which is generally not more than 60, more particularly, up to 40 and more particularly of up to 35. In the same case, the atom can be especially oxygen, and the number of heteroatoms is preferably between 1 and 20. Group B as defined in this paragraph is advantageous in the case of the use of compounds of the invention in aqueous phase compositions.

It should be noted that the invention is applicable to the case where X includes several functions Bₙ(H) or B′(H)_{n′}. These functions may be the same or different.

Compound X typically has an average functionality particularly equal to or greater than one: which can be, for example, between 1 and 10, and more particularly between 1 and 5 and advantageously between 1 and 3.

This average functionality of compound X is the number denoted by r′:

r′=M′ₙ×[B(H)ₙ] or r′=M′ₙ×[B′(H)_{n′}]

wherein:
M′ₙ is the number average molecular weight of compound X,
[B(H)ₙ] and [B′(H)_{n′}] represent the concentrations of functions B(H)ₙ, and
B′(H)_{n′} expressed as mol/g.
   The mass M′ₙ is determined by gel permeation chromatography. The concentration of functions B(H)ₙ and B′(H)_{n′} is calculated by a method of direct potentiometry in the case of functions for which B is N, C(═O)O, C(═O)—N and groups containing phosphorus above or determined indirectly for other functions. The indirect method involves bringing B(H)ₙ and B′(H)_{n′} functions to react with acetic anhydride. An analysis method, such as NMR, can also be used to determine the concentration.

The compound X is also an organic compound with a cycloaliphatic, or heterocyclic aromatic structure. The cycles forming the structure of compound X can be adjacent or linked together by aliphatic chains or by a simple crossover. This is the case, as noted above when B is secondary nitrogen. In the case of aliphatic linking chains, they are preferably short and eventually branched, such as chains of up to 15 carbon atoms, including up to 10, especially at most six and even more particularly containing at most four carbon atoms. These cycles may include short alkyl chains eventually branched, such as chains of up to 10 carbon atoms, including more than 6 atoms, especially up to 4 atoms, and more particularly to 2 atoms. The cycles can be also bicyclic in structure.

In one embodiment, compound X has at least two cycles, particularly at least three. In the case of a mixture of compounds X, it is preferable that at least one of these compounds is a compound with at least two cycles.

The composition can finally have a compound in the form of particles based on a crosslinked polymer substrate.

Compound X typically has a rigid structure. This comprises structures that are sterically hindered or structures with reduced conformational mobility or those that are likely to develop inter- or intra molecular interactions strong enough to resemble highly crystalline, reticulate structures, or compounds with high glass transition temperatures, T_{g}, such as a T_{g} of not less than 0° C., particularly at least 20° C. and more particularly at least 40° C.

In order to have a rigid structure in the sense given above compounds of X may specifically be used, in which at least one and preferably all functions B(H)ₙ or B′(H)_{n′} are directly linked to a carbon cycle. These products after reaction with isocyanate (poly), provide structures with reduced conformational mobility. According to an embodiment especially when X contains a single cyclic moiety, the function B(H)ₙ or B′(H)_{n′} is directly linked to carbon in the cyclic ring.

According to a preferred embodiment of the invention, the function B(H)ₙ is the OH function. In this case, we prefer the compound with a secondary OH function or a primary OH function that is sterically hindered. The term “sterically hindered” refers to an OH function whose beta carbon has at least one alkyl group with at least one carbon atom. As an example of such a case are the neopentylic or isobutyl structures.

The compound X can be chosen from among diols, such as for example, bisphenols, including substituted bisphenols, the type annotated A and F, or hydrogenated and their derivatives. These include the hydrogenated bisphenol A.

One can also mention the polyphenolic derivatives to bridge the éther bisphenols. This comprises product formula (1) or (1′):

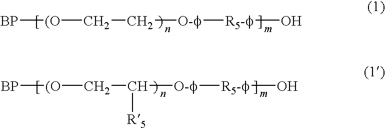

wherein BP designates the remainder of a bisphenol radical, φ a benzene ring, R5 is a linear or branched alkyl radical, R′5 an alkyl radical from C1-C5, such as methyl and n and m whole numbers, with the understanding that n should preferably have a low value to keep the product a rigid structure, for example, no more than 5, preferably not more than 3, and m can be, for example, between 1 and 10.

The hydrogenated derivatives of polyphenolic products may also be used.

Further exemplary X—OH functional compounds include derivatives of cyclopentadiene, dicyclopentadiene, and tricyclopentadiène, which can be obtained by hydroformylation reaction thereof, for example dicyclopentadiene, followed by a hydrogenation for the polycyclic alcohol correspondent, or derivatives of terpenes as terpénylcyclohexanol, and products derived from the series of terpenes like isobornyl and isocamphyl. Examples of these derivatives are norbornadiène, 5-éthylidène-2-norbornène, or limonene.

One can use OH functional cyclanes, especially cyclohexane-diol, tricyclodécane-diméthanol, tricyclodécane-diol, tricyclohexylméthanol or derivatives the terpénylcyclohexanol or isobornylcyclohexanol, derivatives of adamantane for tricyclic condensed décaline-diol or bicycles in the merged.

In one embodiment compound X is the reaction products of carboxylic acid compounds with masked hydroxyl functions. Masked hydroxyl function compounds are defined as epoxy functions compound; carbonates and in this case, preferably cyclic carbonate functions, as carbonate glycerol; or compound with dioxolane function. For the latter function, we can cite the compound 2,2-dimethyl 1,3-dioxolane 4-methanol. The reaction can be affected by an esterification between masked hydroxyl functions and carboxylic functions or a reaction by opening of the masked hydroxyl function with release of the hydroxyl function. In the latter case, one can cite in particular the reaction of carboxylic acids with epoxy based compounds.

The carboxylic acids can be especially acids of formula R₄COOH in which R₄ radical is a aliphatic, cyclic, polycyclic, aromatic or heterocyclic, eventually branched or substituted.

The epoxy functional compound can be aliphatic, cycloaliphatic or heterocyclic and may contain at least one function derived from carboxylic functions (amide or ester functions). These compounds may possibly contain substituents which are eventually branched alkyl chains. The preferred embodiment is epoxy compounds with at least one cyclic ring.

Suitable carboxylic acids include, for example, acetic, propionic, Isobutyric, trimethyl 2,2,2 acetic (pivalique), benzoic, cyclohexanoic, terephthalic, phthalic, or cyclohexanedicarboxylic acids.

Further examples for epoxy compound are styrene oxide, epychlorhydrin and its derivatives, cyclohexene oxide, exo-2,3-époxynorbornane (bicycle), 3.4-époxycyclohexanecarboxylate, hydroxymethyl 3.4, époxycyclohexane, methyl 3,4 époxycyclohexane carboxylate, bis 3.4 époxycyclohexanecarboxylate, 1,3 diméthylpropane 1,3 diol.

As composition X with —OH function, you can also implement the product of the reaction of an epoxy compound function(s) with a phosphate of formula (2) (O)P(OR₆)(OR₇)(OR₈) where R₆, R₇, R₈, are the same or different and designate hydrogen, an alkyl radical, linear or branched, containing from 1 to 25 carbon atoms, a cycloaliphatic radical, an aromatic radical, an aralkyl radical, a polyoxyalkylene chain with the number of oxyalkylene moieties linear or branched between 1 and 25 and the number of carbons in the alkylene chain is between 2 and 6, this may be polyoxyalkylene chain, preferably substituted with a terminal alkyl chain, linear or branched, preferably C₁-C₂₀ or by an aralkyl chain eventually branched, containing number of carbons between 7 and 20; and as a condition in the formula (2) that at least one of R6, R7, R8 is a hydrogen atom. For compound formula (2) we prefer those with a cyclic structure.

Compounds that can also be used as a X include reaction products of an epoxy compound to function with a polyaminoéther according to formula (3), (3′), or (4):

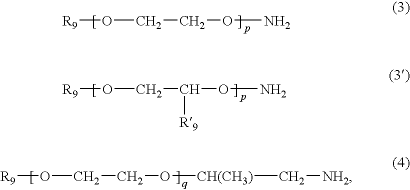

wherein:

R₉ is hydrogen, an alkyl radical, containing C₁-C₄ carbon atoms, a radical CH₂CH₂NH₂ or CH₂CH(CH₃)NH₂,

R′9 is an alkyl radical, containing C₁-C₄ carbon atoms,

p and q are integers ranging between 2 and 10, preferably between 2 and 5;

or the product of the reaction of a compound containing an epoxy functionality with a morpholine or any derivation thereof.

As noted above, the compound of the invention resulting from the reaction of a compound X, as described above, with a (poly) isocyanate with average functionality greater than 2.

By (poly)isocyanate with average functionality greater than 2 we refer to compounds that have at least one isocyanate cycle, a biuret base, an allophanate function or an acylurea function. It also includes compounds that have at least one uretidinedione cycle, and the isomers of isocyanurates, such as iminooxadiazinedione. These compounds can be obtained by homo or heterocondensation of monomers selected from isocyanates that are aliphatic, cycloaliphatic, arylaliphatic, aromatic and heterocyclic and among them di-isocyanates and tri isocyanates structures are included;

Suitable aliphatic and cycloaliphatic isocyanates include, for example, the following products: 1,6-hexaméthylène di-isocyanate (HDI), -1,12-dodécane di-isocyanate, Cyclobutane-1,3-di-isocyanate, Cyclohexane-1,3 and/or 1,4-di-isocyanate, 1-isocyanato-3,3,5-triméthyl-5-isocyanatométhyl cyclohexane (Isophorone di-isocyanate) (IPDI), Isocyanatométhyl di-isocyanates, including 4-isocyanatométhyl-1-8 diisocyanate (TTI), 2.4 and/or 2,6-hexahydrotoluoylène di-isocyanate (H6TDI), Hexahydro-1,3 and/or 1,4-phénylène di-isocyanate, Perhydro-2.4 and/or 4,4′-diphénylméthane di isocyanate (H12MDI), and, in general, the hydrogenation products of precursor aromatic amines or carbamates, Bis-isocyanométhylcyclohexane (especially 1.3 and 1.4) (ICB); -Bis-isocyanométhylnorbornane (NBDI), 2-méthylpentaméthylène-1,5 di isocyanate (MPDI), Tétraméthylxylilène di-isocyanate (TMXDI) -Ester-lysine di- or tri isocyanate (IG or LTI), and Triisocyanates such as 4-methyl isocyanato 1.8 octaméthylène diisocyanate

As examples, non-restrictive aromatic isocyanates are: 2,4- and/or 2,6-oluylène di-isocyanate (TDI), Diphenylmethane-2,4′ and/or 4,4′-di-isocyanate (MDI), 1.3- and/or 1,4-phénylène di-isocyanate, Triphenylmethane-4,4′,4″-triisocyanate, and oligomers of TDI or MDI.

In one embodiment, only limited quantities aromatic derivatives are used because they can lead to coatings which may undergo coloring during aging, particularly in the event of exposure to ultra-violet radiation, such as in the sun. Therefore, aliphatic and cycloaliphatic derivatives including at least one of the NCO functions, preferably two, that are not directly attached to the aliphatic ring are generally preferred.

In one embodiment, the (poly) isocyanate has an average functionality of at least 2.5 and even more typically at least 3. Typically, the average functionality is not more than 30, especially of not more than 15 and more particularly of up to 10, for example, it may be between 3 and 6.

The (poly)isocyanate used can be from a mixture with monomers above, but in this case, the monomer content is not more than 50%, particularly not greater than 30%, especially not more than 20% and still especially not more than 10%.

In one embodiment, (poly)isocyanates, have a viscosity of up to 40,000 mPa·s, especially of up to 20,000 mPa·s, more particularly of up to 10,000 mPa·s, and preferably not more than 5,000 mPa·s and even more preferably not more than 2500 mPa·s. This corresponds to a viscosity measured at 100% dry content at 25° C.

The compositions with isocyanate functionality in this invention are obtained by reacting a compound X with a (poly) isocyanate of the type described above.

This reaction is conducted with a weight ratio of compound X/[compound X+(poly)isocyanate] of not more than 50%. This ratio may be not more than 40%, especially not more than 25% and more particularly of up to 20%. Usually it is at least 1%, particularly at least 2%, and more particularly at least 5%.

In one embodiment, the respective functionalities of compound X and (poly)isocyanate are selected in such a way that after the reaction yields a compound that can be formulated easily, that is usable in the conditions for the sought application. The term “formulable” is used herein to indicate a product that can at 70% dry content and 25° C. usually present viscosity of up to 20,000 mPa·s, especially of up to 10,000 mPa·s and preferably not more than 6000 mPa·s. It should be clearly understood that this value is given here as an example only and can not be regarded as exhaustive.

The conditions that may be driving the reaction between the compound X and (poly)isocyanate will now be described in greater detail.

Generally, the procedure is conducted so that the molar ratio B(H)ₙ/NCO is between 1 and 50% preferably between 2 and 30% and beneficially between 3 and 25%. These ratios are selected by the skilled person depending on the molecular weight, the functionality of each of the products involved and compounds that we seek.

The general method used here also synthesize polyisocyanate compounds useful in the composition of the present invention using conventional reaction conditions for isocyanate functions with the functions B(H)ₙ at a temperature of between 20 and 200° C., preferably at a temperature of 25 and 150° C. In some cases, a catalyst can be added, in general these catalysts are organometallic compounds that are Lewis acids. It may also include derivatives of tin as dibutyl tin dilaurate, dibutyl tin diacetate, acétylacétonates zirconium or aluminum or acylates (acetate, octoate . . . ) Bismuth, the list of catalysts not exhaustive.

The amount of catalyst useful in obtaining compounds of the invention can be set between 0 and 1,000 ppm, advantageously between 0 and 500 ppm, and even more preferably between 0 and 250 ppm compared to the amount of (poly)isocyanates.

The synthesis is conducted in bulk or with solvent depending on the viscosity of the final compound obtained. The synthesis solvent is generally selected from esters, such as n-butyl acetate, tert-butyle acetate, aromatic solvents such as SOLVESSO 100, and ketones such as méthylisobutyle ketone.

It may be noted that it is possible to carry out a distillation of compound X, as well as the synthesis solvent above to remove residual traces of water in the reaction.

After the general description above, the synthesis of compounds will now be described in more detail depending on the type of isocyanate functionality compound we are trying to prepare. In the description that follows the rate of isocyanate functions consumed is expressed as a percentage (%) and corresponds to the following formula:

(T NCO Start−T NCO End/T NCO Start)×100,

wherein:

“T NCO start” represents the titrated value of the isocyanate functionality in the reactive mixture at the start of the reaction, and

“T NCO End” represents the titre value of isocyanate functionality of the reaction mixture at the time of measurement.

The measure of the rate of isocyanates functions consumed is made according to standard method NF T 52-132 which is a method that uses dosing with the N, N dibutylamine (DBA).

From this dosage amount we can also estimate the rate of transformation of starting isocyanate compound. When an isocyanate function of this isocyanate compound has been transformed during the course of the reaction we also consume a molecule of this isocyanate. Thus for the monomer hexamethylene diisocyanate, which is a diisocyanate, the rate of conversion into equivalent isocyanate to about double the value found for the titre value of isocyanates.

In the case of a compound according to the invention that contains isocyanate functions and also urethane functionalities, the preparation process involves the following steps:
(A) introduction of a mixture of (poly) isocyanate (s) in a reactor equipped with a system of agitation and controller;
(B) addition of solvent;
(C) addition to (poly)isocyanate or mixture of (poly)isocyanates a compound X or mixture of compounds according to X with functionalities B(H)ₙ, (B(H)ₙ being in the present case (preparation of a isocyanate functionality compound/Urethane) an OH);
(D) stirring the reaction mixture under current of an inert gas such as argon or nitrogen;
(E) adding any additives to reaction blend such as antioxidants or stabilization agents such as trialkyl or triaryl phosphites, phenolic or aromatic compounds such as sterically hindered 2,6 tert-dibutyl phenol or oligomeric derivatives of these compounds;
(F) reaction at a temperature between 80 and 130° C. until the rate of transformation from isocyanates titre value is equal to the amount of molecular functions B(H)ₙ in the reagents. So in this case (formation of urethane bonds) the quantity of isocyanate functions consumed will be equal to at least 90% of the amount of molecular functions B(H)ₙ, preferably higher than 95% of that amount and more preferentially equal to the total quantity of functions B(H)ₙ introduced, and
(G) recovery of the reaction products once the rate of transformation is reached.

In the case of a compound according to the invention that contains isocyanate function(s) and also to allophanate function(s), the process of preparation utilizes, again, a compound X (or a mixture of compounds X) with OH function.

The process includes steps (a) to (e) above and an additional step, after the step (d), that involves addition of one of Lewis acid catalysts (dibutyl tin dilaurate, acétylacétonate or zirconium) in the quantities shown above.

The process also includes a step (f), in which the reaction is conducted at a temperature between 100 and 150° C. until the rate of transformation of isocyanate functionalities is equal to approximately twice the amount of molecular functions B (H)ₙ in the reagents. Indeed, an allophanate functional compound is created in the reaction product of an isocyanate compound containing urethane functionalities, which is itself the reaction product of an isocyanate compound with the hydroxyl functional compound. For the transformation into allophanate we theoretically consume two moles of isocyanate for every one mole OH function, and in practice here, we continue the reaction so as to consume a quantity of at least one mole and between one and two moles of isocyanates functions, depending on the properties being sought from the compound X.

The synthesis of compounds containing isocyanate functionality also involves urea functional compounds X whose B(H)ₙ is either a primary amine or a secondary amine. The preparation process takes place in the same manner as for the synthesis of isocyanate functional compounds with urethane functions except that the reaction temperature is between room temperature and 80° C. The reaction does not require specific catalysts. The reaction is stopped when the rate of transformation of isocyanate functions is equal to the amount of molecular functions B(H)ₙ (in this case a primary or secondary amine) to react. So in this case with the formation of urea bonds, the amount of consumed isocyanate functions will be equal to at least 90% of the amount of molecular functions B(H)ₙ or B′(H)ₙ, preferably at least 95% of this amount, and even more preferably equal to the total quantity of functions B(H)ₙ introduced.

The synthesis of polyisocyanates containing compounds with isocyanate functionality and also biuret functionality involves compounds X whose B(H)ₙ is either a primary amine is a secondary amine. It proceeds in the same manner as for the synthesis of isocyanate compounds and urethane functionalities except that the reaction temperature is between 100 and 150° C. The reaction can be catalyzed by the addition of acidic compounds such as propionic acid or dialkyl phosphates. A biuret compound is the product of reaction of an isocyanate compound to a compound containing urea functionality the latter is itself the product of reaction of a compound based on an isocyanate amine. For the transformation into biuret, theoretically it consumes two moles of isocyanate according to one mole of amine function, and in practice here, we conduct the reaction so as to consume a quantity of at least one mole or between one and two moles of isocyanate functions, depending on the properties being sought for the compound X.

In the case of compounds X whose functions B(H)ₙ are functions SH, we use the same kind of process as that described for obtaining the isocyanate compound with urethane functions. Consumption of isocyanate functions will be the same as that of the urethane functions if the reaction is stopped at thio-urethane compounds. It will correspond to the rate of transformation of NCO functions of the allophanate process if we seek thioallophanate compounds.

As far as X compounds whose functions B(H)ₙ are amide functions the process will be the same except that the operating conditions will be at a reaction temperature between 100 and 150° C., and the possible presence of a Lewis acid catalyst. The reaction is stopped when the rate of transformation of isocyanate functions is equal to the amount of molecular functions B(H)ₙ (of primary or secondary amide) in the reaction mixture. The amide functions can result from a reaction between the isocyanate functionalities and acid functionalities.

In the case of compounds X with different functions B(H)ₙ or B′(H)_{n′} the operating conditions may be adapted to the compounds that we want to achieve. Broadly speaking, it should be noted that the terms of reactions of an isocyanate functional compound with a compound X with a labile hydrogen are well known to the skilled person and we could use this “Methoden der Organischen” Houben Weyl Chemie, Georg Thieme Verlag 1983 to guide us for general structure.

In all cases which have just been described, the structures of the compounds are confirmed by known analysis techniques such as infra-red spectroscopy, and proton or carbon nuclear magnetic resonance spectrometry (NMR).

In one embodiment, the composition of the present invention further comprises a catalyst for the reaction of the isocyanate and a reactive hydrogen compound. Examples of suitable catalysts include tertiary amines or amidines and organometallic compounds and mixtures thereof. Suitable amines are both acyclic and, in particular, cyclic compounds, such as triethylenediamine, tetramethyl butanediamine, 1,4-diazabicyclooctane (DABCO), 1,8-diazabicyclo-(5.4.0)-undecene, N,N-dimethylcyclohexyl amine, and N,N-dimethyl ethanolamine, as well as mixtures thereof. Suitable organometallic compounds include organotin, organozinc, organobismuth, and organozirconium compounds, as well as mixtures thereof.

In one embodiment, the composition of the present comprises one or more dialkyl tin(IV) carboxylates (X═O—CO—R) as a curing catalyst. The carboxylic acids contain 2, preferably at least 10 and more preferably 14 to 32 carbon atoms. In one embodiment, the catalyst comprises a dialkyltin dicarboxylate, wherein the alkyl groups of the dialkyltin dicarboxylate are each independently selected from alkyl groups containing from 1 to 12 carbon atoms per group and the carboxylate groups of the dialkyltin dicarboxylate are each independently selected carboxylate groups containing from 2 to 32 carbon atoms per group. Dicarboxylic acids may also be used. The following are specifically mentioned as acids: adipic acid, maleic acid, fumaric acid, malonic acid, succinic acid, pimelic acid, terephthalic acid, phenyl acetic acid, benzoic acid, acetic acid, propionic acid and, in particular, 2-ethylhexanoic acid, caprylic acid, capric acid, lauric acid, myristic acid, palmitic acid and stearic acid. Specific dialkyl tin carboxylates include dibutyl tin diacetate, dioctyl tin diacetate, dibutyl tin maleate, dibutyl tin bis-(2-ethylhexoate), dibutyl tin dilaurate; tributyl tin acetate, bis-(beta-methoxycarbonylethyl)-tin dilaurate and bis-(beta-acetylethyl)-tin dilaurate.

The coating composition of the present invention may, optionally, further comprise one or more solvents. Such solvents may be added to the composition separately or may be added to the composition as a mixture with the polyisocyanate oligomer, the polyol or with both the polyisocyanate oligomer and the polyol. Suitable solvents include aromatic solvents, such as, for example, xylene, toluene and aliphatic solvents, such as, for example, n-butyl acetate, t-butyl acetate, acetone, as well as mixtures of such solvents, such as, for example, Aromatic 100 (a mixture of aromatic solvents, available from ExxonMobil).

The composition of the present invention may, optionally, also include minor amounts of additives known in the coatings art, such as, for example, flow aids, flatting agents, defoamers, leveling aids, surfactants UV absorbers and pigments. In a preferred embodiment, the coating composition of the present invention is a clear, that is, non-pigmented, coating.

The composition of the present invention is made by combining the components in the relative amounts described above and mixing the components to obtain a substantially homogeneous mixture.

The composition of the present invention is applied to a substrate, which may be any solid material, preferably to a metal substrate, by known application techniques, such as, for example, spraying, draw down bar, spinning, brushing, dipping or roller.

The curing or cross-linking of the ambient fast-dry coating composition of the present invention can take place after application to a substrate at temperatures of from 10° C. to 45° C. In a preferred embodiment, the coating composition of the present invention is cured at a temperature of from about 15° C. to about 30° C., more preferably from about 20° C. to about 25° C. In a preferred embodiment, the coating is then allowed to post-cure at ambient conditions for at least 7 days.

### EXAMPLE 1

A polyisocyanate oligomer was made by reacting 92.5 mole % biuret (HDB) of the below formula, (prepared by removing one mole of carbon dioxide from 6 moles of hexamethalene diisocyanate), with 7.5 mole % of a HBPA/PE polyester derived from the reaction of 99.6 percent by weight (wt %) HBPA of the below formula, 0.1 wt % hexane 1,6 diol, 0.1 wt % phthalic anhydride, 0.1 wt % maleic anhydride and 0.1 wt % triméthylol propane, at 80% solids in n-butyl acetate.

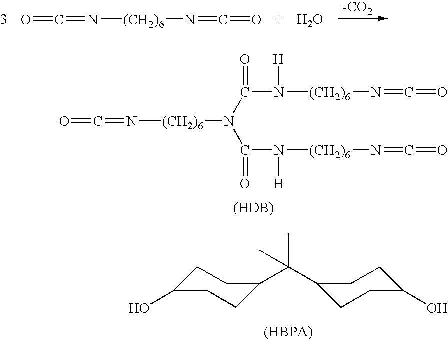

### EXAMPLE 2

Two component polyurethane coating compositions of Examples 2A-1 to 2A-5, 2B-1 to 2B-5, 2C-1 to 2C-5 and 2D-1 to 2D-5, 2E-1 to 2E-5 were prepared by combining a polyisocyanate oligomer from those listed in Table 1 and a polyol from those listed in Table 2 at 47% total solids to give clear solutions at an index (NCO/OH ratio) of 1.05 in a mixed solvent (n-butyl acetate[n-BA]/methyl amyl ketone [MAK]/methyl isobutyl ketone [MIBK] in the approximate n-BA/MAK/MIBK ratio 20/55/25) and about 200 ppm dibutyl tin dilaurate catalyst.

TABLE I

| | | Solid content | |
|---|---|---|---|
| PI# | Polyisocyanate oligomer | (wt %) | NCO (%) |
| PI-1 * | Tolonate ® HDB oligomer ¹ | 100 | 22 |
| PI-2 * | Tolonate ® XIDT oligomer ² | 90 | 18.3 |
| PI-3 * | Tolonate ® HDT oligomer ³ | 100 | 22 |
| PI-4 * | Tolonate ® XFD90B oligomer ⁴ | 90 | 17.9 |
| PI-5 # | oligomer of Example 1 | 80 | 12.9 |

* = comparative
# = Invention
¹ Tolonate ® HDB oligomer is an HDI polyisocyanate based on biuret sold by RHODIA, with isocyanate content of 22 wt %, viscosity of 9000 +/− 2000 mPas at 25°, and isocyanate functionality of 3.7.
² Tolonate ® XIDT oligomer is a 70/30 blend by weight of Tolonate ® HDT oligomer and Tolonate ® IDT 70B oligomer₅.
³ Tolonate ® HDT oligomer is an HDI polyisocyanate based on isocyanurate sold by RHODIA, with isocyanate content of the order of 22%, viscosity of 2400 +/− 400 mPa · s at 25° C., and isocyanate functionality in the order of 3.6
⁴ Tolonate ® XFD-90B oligomer is an: HDI polyisocyanate based on isocyanurate sold by RHODIA, with isocyanate content in the range of approximately 17.9% and a viscosity of 2000 +/− 1000 mPa · s at 25° C.
Tolonate ®IDT 70B oligomer is a polyisocyanate based on isocyanurate diisocyanate (IPDI) sold by RHODIA, with isocyanate of approximately 12.3% by weight, and a viscosity of 600 +/− 300 mPa · s at 25° C.

The polyol components in Table 2 were acrylic polyols as sold under the name “JONCRYL™” by Johnson Polymers (now BASF). M_{w} refers to the weight average molecular weight. J-922 with J-902 compare an increase in T_{g} at similar equivalent weights and low M_{w}. J-902 with J-911 and J-587 with J804 compare the influence of equivalent weight at similar T_{g}.

TABLE II

| | | | | Equivalent |
|---|---|---|---|---|
| PO # | Commercial Name | Tg (° C.) | M_{w} (g/mole) | weight |
| PO-A # | Joncryl ™ 922 polyol | −5 | 1300 | 400 |
| PO-B # | Joncryl ™ 902 polyol | 20 | 2330 | 500 |
| PO-C # | Joncryl ™ 911 polyol | 20 | 3000 | 800 |
| PO-D * | Joncryl ™ 587 polyol | 63 | 5700 | 600 |
| PO-E * | Joncryl ™ 804 polyol | 60 | 6000 | 1300 |

* = comparative
# = Invention

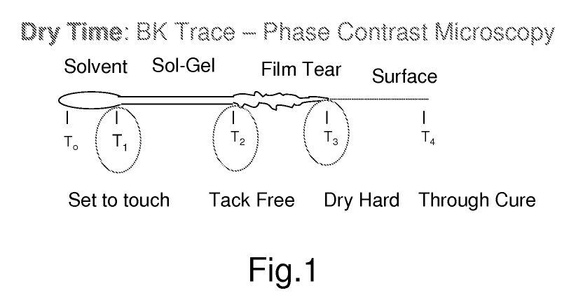

The dry times for the coating compositions were measured with a Byk Gardner BK Drytime recorder, which is essentially a pin with a rounded tip translating at a constant velocity across a wet film (150 μm) of the 2K PU formulation on a glass strip. As the pin translates and the film solidifies there are changes in the track left behind as shown in FIG. 1. T₀ is the starting point, T₁ marks the point where the solvent evaporates (Set to touch), with a track down to the glass substrate till T₂. T₂ (tack free time) marks the sol-gel transition as the bulk of the film starts to solidify and the needle leaves the glass substrate tearing through the film thickness. At T₃ (dry hard time) the needle pops to the surface of the solidified coating leaving a faint scratch on the surface till T₄ (though cure) is achieved when no marks are left on the film. T₁, T₂, and T₃ values were obtained for each of the combinations of polyol with a range of isocyanates to evaluate comparative drytimes. Results are set forth in Table IV below as drytimes (minutes) and differential dry times (% ΔT_{avg}).

TABLE III

| | | | | | | Drytime |
|---|---|---|---|---|---|---|
| | | | T1 | T2 | T3 | Differential |
| Ex. # | PO # | PI # | (min) | (min) | (min) | (% ΔT_{avg}). |
| 2A-1* | PO-A | PI-1 | 40 | 90 | 130 | 17 |
| 2A-2* | PO-A | PI-2 | 32 | 81 | 149 | 10 |
| 2A-3* | PO-A | PI-2 | 43 | 71 | 145 | 13 |
| 2A-4* | PO-A | PI-4 | 40 | 61 | 125 | 0 |
| 2A-5# | PO-A | PI-5 | 28 | 52 | 102 | −21 |
| 2B-1* | PO-B | PI-1 | 43 | 145 | 308 | 29 |
| 2B-2* | PO-B | PI-2 | 35 | 167 | 434 | 38 |
| 2B-3* | PO-B | PI-2 | 22 | 152 | 361 | 8 |
| 2B-4* | PO-B | PI-4 | 25 | 120 | 323 | 0 |
| 2B-5# | PO-B | PI-5 | 18 | 105 | 263 | −21 |
| 2C-1* | PO-C | PI-1 | 38 | 164 | 399 | 20 |
| 2C-2* | PO-C | PI-2 | 48 | 235 | 455 | 53 |
| 2C-3* | PO-C | PI-2 | 39 | 212 | 434 | 35 |
| 2C-4* | PO-C | PI-4 | 25 | 164 | 361 | 0 |
| 2C-5# | PO-C | PI-5 | 27 | 143 | 339 | −5 |
| 2D-1* | PO-D | PI-1 | 20 | 66 | 105 | 5 |
| 2D-2* | PO-D | PI-2 | 19 | 58 | 114 | 1 |
| 2D-3* | PO-D | PI-2 | 20 | 54 | 118 | 2 |
| 2D-4* | PO-D | PI-4 | 16 | 59 | 128 | 0 |
| 2D-5* | PO-D | PI-5 | 15 | 56 | 135 | −3 |
| 2E-1* | PO-E | PI-1 | 10 | 25 | 78 | 3 |
| 2E-2* | PO-E | PI-2 | 10 | 24 | 77 | 3 |
| 2E-3* | PO-E | PI-2 | 8 | 23 | 63 | −2 |
| 2E-4* | PO-E | PI-4 | 9 | 24 | 62 | 0 |
| 2E-5* | PO-E | PI-5 | 10 | 24 | 57 | 1 |

*= comparative
#= Invention

T₁, T₂, and T₃ values obtained for the acrylic polyol J-922 (PO-A), a low M_{w}, low equivalent wt., low T_{g} polyol, show a remarkable improvement in drytimes for PI-5 compared to all other polyisocyanates. PI-5 was the only polyisocyanate within the invention. Using the current state of the art fast-dry polyisocyanate XFD90B (PI-4) as the benchmark, the average drytime differential was calculated according to the formula % ΔT_{avg}=[Σ(ΔTᵢ/T_{i,PI-4})*100]/3. The % ΔT_{avg} clearly indicate that though PI-4 has an average dry-time (10-20) % faster than HDT, HDB and XIDT; PI-5 outperforms the benchmark itself with % ΔT_{avg}˜−20% which is 20% faster drytimes compared to PI-4.

Two examples of polyols with T_{g} at or below room temperature (20 C.) and molecular weights, Mw, below 2500 (PO-A and PO-B) showed similar comparative performance with drytime reduction % ΔT_{avg} of 20% compared to PI-4. The absolute values of drytimes of PO-B are higher compared to PO-A for all polyisocyanates as the curing and the mobility of the polyol slows down with increased T_{g} but the relative performance is maintained. Increasing the equivalent weight and M_{w} in PO-C reduces the difference in performance between PI-4 and PI-5 with % ΔT_{avg,PI-5}<−10% with slower dynamics. However, with PO-C, there is an improvement in T2 and T3 with PI-5 compared to PI-4.

As the T_{g} of the polyol is increased above room temperature and with increasing molecular weight, there ceases to be any difference in % ΔT_{avg} for all the polyisocyanates. The absolute values of the drytimes are lower but the system does not have time to crosslink, giving poor chemical resistance, as shown by the data in Table IV, and therefore use of these polyols is outside the invention. The mobility and reactivity of the polyol are paramount in delivering performance with PI-5. Similar experiments were performed with polyester polyols which are low T_{g} high mobility polyols due to a flexible backbone. These polyols showed a similar enhancement in performance of PI-5 over PI-4.

The data in Table 11 clearly shows that with low molar mass (Mw of 2500 or less) and T_{g}<25° C. there is a 5% or more reduction in dry time compared to state of the art for fast drying time, PI-4. This is further tested by measurement of chemical resistance as shown in Table IV where the coating is exposed to these chemicals for a 24 hr spot test as is the norm in the industry. Performance is measured by visual inspection on a scale from 0 to 5 with 5 being the best coating. The data shows better performance for PI-5 for polyols with T_{g}<25° C. Shaded cells indicate deficiency.

TABLE IV

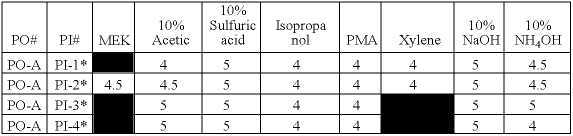

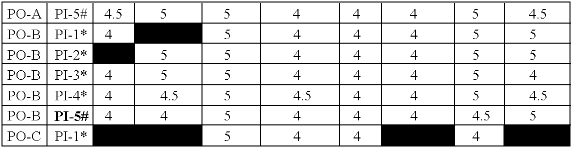

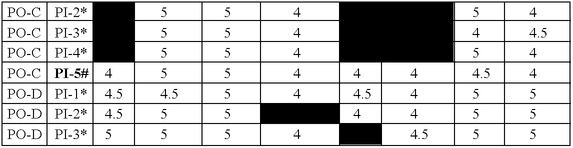

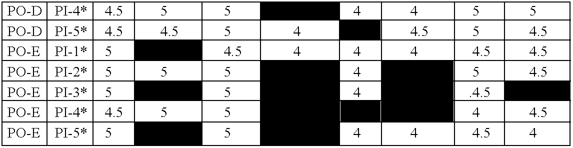

### EXAMPLE 3

A series of polyisocyanate oligomer compounds, PI-6 to PI-10, were made in manner analogous to that described above in Example 1, but with different relative amounts by weight of the HBPA/PE to react with the HDB. The isocyanate oligomer compounds PI-6 to PI-10 were each used to make a polyurethane coating composition 3A-6 to 3A-10 in a manner analogous to that described in Example 2 above using PO-A (Joncryl 922) as the polyol. Dry times were measured using Byk Gardner BK Drytime recorder as described above in Example 2. Results are set forth in Table V below as drytimes (minutes)

TABLE V

| | | Relative amount of | T1 | T2 | T3 |
|---|---|---|---|---|---|
| Ex # | PI # | HBPA/PE (wt %) | (min) | (min) | (min) |
| 3A-6# | PI-6 | 8 | 35.4 | 58.1 | 118.7 |
| 3A-7# | PI-7 | 10.3 | 34.1 | 54.3 | 104.8 |
| 3A-8# | PI-8 | 12.4 | 36.6 | 48.0 | 92.2 |
| 3A-9# | PI-9 | 15.3 | 29.0 | 49.3 | 82.1 |
| 3A-10# | PI-10 | 20.5 | 18.9 | 30.3 | 79.6 |

#= invention

### EXAMPLE 4

Comparative evaluation of performance of isocyanates was also conducted with a polyester polyol CCP Chempol 211-2224 to determine fast dry performance. This polyester polyol (PO-F) has a T_{g}<0° C. and a molar mass of M_{w}˜15000 g/mol approx. This underscores the efficacy of PI-5, according to the invention, in reducing drytimes for preparation of polyurethane coatings provided the polyol has sufficient mobility at room temperature to form a cross-linked network. The results are set forth in Table VI.

TABLE VI

| | | | | | | Average |
|---|---|---|---|---|---|---|
| | | | | | | Drytime |
| | | | T1 | T2 | T3 | Diff. |
| Ex # | PO # | PI # | (min) | (min) | (min) | (% ΔTavg) |
| 4F-1* | PO-F | PI-1 | 54 | 134 | 212 | 10 |
| 4F-3* | PO-F | PI-3 | 45 | 153 | 219 | 13 |
| 4F-4* | PO-F | PI-4 | 61 | 110 | 176 | 0 |
| 4F-5# | PO-F | PI-5 | 50 | 96 | 145 | −16 |

*= comparative
#= Invention

The present invention, therefore, is well adapted to carry out the objects and attain the ends and advantages mentioned, as well as others inherent therein. While the invention has been depicted and described and is defined by reference to particular preferred embodiments of the invention, such references do not imply a limitation on the invention, and no such limitation is to be inferred. The invention is capable of considerable modification, alteration and equivalents in form and function, as will occur to those ordinarily skilled in the pertinent arts. The depicted and described preferred embodiments of the invention are exemplary only and are not exhaustive of the scope of the invention. Consequently, the invention is intended to be limited only by the spirit and scope of the appended claims, giving full cognizance to equivalents in all respects.

What is claimed is:

1. A fast drying, two component polyurethane coating composition, comprising a mixture comprising:
(a) a first component comprising one or more polyol compounds having a glass transition temperature (Tg) of less than or equal to about 25° C., and
(b) a second component, comprising the reaction product of a (poly)isocyanate oligomer having an average NCO functionality of greater than 2 with a compound X comprising a substrate portion comprising one or more cycloaliphatic rings, one or more heterocyclic rings, one or more aromatic rings, or a particle of a crosslinked polymer, and functional groups covalently bonded to such substrate portion, wherein the functional groups comprise:
(i) one or more functional groups according to:
—B(H)ₙ
wherein:
n is a number equal to 1 or 2,
H is a labile hydrogen and
B is O, S, N, N is a primary or secondary nitrogen, or groups —C(═O)O, C—(═O)N, O═P(O)₂; O═P(O)OR₁; O═P(O)₃; O═P(O)₂OR₁; or O═P(O)—OR₁, and
R₁ is an alkyl or aralkyl radical, optionally branched, or an alkyl chain interrupted by a heteroatom; or
(ii) one or more functional groups according to:
B′(H)_{n′}
wherein:
n′ is a number equal to 1, 2 or 3,
H is a labile hydrogen,
B is —SiR₂R₃R₄, and
R₂, R₃, and R₄ are each independently oxygen, an alkyl radical substituted with a reactive (poly)isocyanate group, or a radical such as aralkyl, aryl, —O-alkyl, or —O-aralkyl,
further provided that:
(iii) when B is a secondary nitrogen atom, and the substrate portion of compound X comprises a cycloaliphatic ring, then the substrate portion of compound X must comprise at least two such cycloaliphatic rings, and
(iv) the reaction is conducted with a weight fraction of compound X/[compound X+(poly) isocyanate] of not more than 50%.

2. The fast drying, two component polyurethane composition of claim 1 wherein the first component comprising one or more polyol compounds having a glass transition temperature of less than or equal to about 25° C. and a molecular weight, Mw, of less than 5000.

3. The fast drying, two component polyurethane composition of claim 1 wherein the one or more polyol compounds each have Mw and Tg such that Mw (g/mol)+500 times Tg (° C.) is less than 17500.

4. The fast drying, two component polyurethane composition of claim 1 wherein the second component is the reaction product of a biuret prepared from hexamethylene diisocyanate (HDI) with a hydrogenated bis-phenol A (HBPA).

5. The fast drying, two component polyurethane composition of claim 1 wherein the first component is a polyol having a Tg in the range of −5 to 20° C. and Mw in the range of 3000 to 1300 g/mole.

6. The fast drying, two component polyurethane composition of claim 1 wherein the one or more polyols are selected from the group consisting of acrylic polyols and polyester polyols having a glass transition temperature (Tg) of less than or equal to about 25° C.

7. The fast drying, two component polyurethane composition of claim 1 wherein the second component is the reaction product of a biuret prepared from hexamethylene diisocyanate (HDI) with a hydrogenated bis-phenol A (HBPA).

8. The fast drying, two component polyurethane composition of claim 1 wherein the one or more polyol is selected from the group consisting of acrylic and polyester polyols and each have Mw and Tg such that Mw (g/mol)+500 times Tg (° C.) is less than 17500, and wherein the second component is the reaction product of a biuret prepared from hexamethylene diisocyanate (HDI) with a hydrogenated bis-phenol A (HBPA).

9. A fast drying, two component polyurethane coating composition, comprising a mixture comprising:
(a) a first component comprising one or more polyol compounds having a glass transition temperature (Tg) of less than or equal to about 25° C., and
(b) reaction product of a biuret prepared from hexamethylene diisocyanate (HDI) with a hydrogenated bis-phenol A (HBPA).
